(19) United States
(12) Patent Application Publication
(10) Pub. No.: US 2009/0180403 A1
(43) Pub. Date: Jul. 16, 2009

(54) MULTI-BAND AND MULTI-MODE RADIO FREQUENCY FRONT-END MODULE ARCHITECTURE

(76) Inventor: Bogdan Tudosoiu, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/013,129

(22) Filed: Jan. 11, 2008

(51) Int. Cl. H04B 7/005; H04B 1/04

(52) U.S. Cl. 370/278; 455/93

(57) ABSTRACT

A multi-band, multi-mode radio frequency (RF) front-end module is capable of operating in widely different frequency bands, including at least one of the following frequency ranges: 700 megahertz (MHz), 850 MHz, 900 MHz, 1800 MHz, 1900 MHz, 2.1 gigahertz (GHz) or 2.4 GHz. The multi-band, multi-mode RF front-end module is also capable of operating according to different mobile communication standards, including at least one of the following standards: GSM, WCDMA, EDGE or LTE. The multi-band, multi-mode RF front-end module includes a plurality of broadband amplifiers, a plurality of transmit (TX) paths selectively connectible to respective broadband power amplifiers; and a plurality of switches. One switch is selectively operable to couple one plurality of TX paths to one broadband power amplifier operable to amplify TX signals within one range of frequencies. A second switch is selectively operable to couple a second plurality of TX paths to a second broadband power amplifier operable to amplify TX signals within a second range of frequencies.

### TECHNICAL FIELD OF THE INVENTION

The present invention relates generally to communication devices and, more particularly, to RF front-end modules in multi-mode, multi-band communication devices, such as mobile phones.

### BACKGROUND

Mobile and/or wireless electronic devices are becoming increasingly popular. For example, mobile telephones, portable media players and portable gaming devices are now in wide-spread use. In addition, the features associated with certain types of electronic devices have become increasingly diverse—and increasingly dependent on bandwidth. To name a few examples, many electronic devices have cameras, text messaging capability, Internet browsing capability, electronic mail capability, video playback capability, audio playback capability, image display capability and handsfree headset interfaces. Some of these features utilize peripheral radios that also require access to the antenna of the electronic device, thereby raising the level of complexity in the architecture of the electronic device.

During recent years, the mobile communications industry has been focused on developing standards for digital solutions for mobile communication systems in order to increase bandwidth and to allow effective communication of more complex data. Presently, the mobile communication technology is about to enter the so-called “Super 3G” (third generation), providing greater efficiency and higher data rates than the current 3G and former 2G digital systems.

As technologies evolve, developers carefully ensure interoperability between the older and newer systems, so that existing investments may be re-used as much as possible. Moreover, co-existence of standards is particularly important for people who want to use the other facilities of an electronic device such as: Bluetooth, GPS (global positioning service), DVB-H (digital video broadcasting-handheld), MediaFlo, etc.

GSM (Global System for Mobile Communications), the main 2G technology, WCDMA (Wideband Code Division Multiple Access), the main 3G technology, and evolutions of these technologies all use a common core network, providing maximum flexibility for implementing different systems across different coverage areas. For example, when a mobile phone user moves from a WCDMA coverage area to a GSM area, the WCDMA system can automatically “hand over” the connection to the GSM system, without requiring any action from the user. However, handover between different systems requires a multi-mode mobile device. Moreover, each digital system operates within different frequency bands, and each frequency band may be assigned to specific regions of the world. In addition, peripheral radios, e.g., Bluetooth, GPS, DVB-H, WLAN, WiMax, etc., operate on separate non-cellular frequency bands. Thus, in order to accommodate full inter-frequency and inter-system handover, the mobile phone must be both multi-band and multi-mode.

The range of frequencies covered by each digital system varies widely. Current GSM technology covers frequencies in a range around 850 megahertz (MHz), 900 MHz, 1800 MHz and 1900 MHz. The frequencies at 850 MHz are referred to as GSM850 or GSM800. The frequencies at 900 MHz are referred to as GSM900 or E-GSM-Band (Extended GSM), since only 890 MHz to 915 MHz and 935 MHz to 960 MHz were originally intended for GSM systems. The formerly called DCS (Digital Cellular System) and PCS (Personal Communication System) bands are now called GSM1800 and GSM1900, respectively. The frequencies of GSM850 and GSM900 have a higher range compared to the frequencies of GSM1800 and GSM1900 due to their longer wavelengths and thus the lower dispersion. For better understanding, GSM850 and GSM900 are defined as part of a low-band frequency, while GSM1800 and GSM1900 are defined as part of a high-band frequency.

EDGE (Enhanced Data Rates for GSM Evolution), another 3G technology, adds a packet-data infrastructure to GSM and is fully backward-compatible with older GSM networks. Thus, EDGE can be deployed within the existing GSM frequency bands (850, 900, 1800 and 1900 MHz).

UMTS (Universal Mobile Telecommunications System) is a mobile communication standard that employs WCDMA technology, and often the terms UMTS and WCDMA are used synonymously. The present disclosure covers both UMTS and WCDMA technologies. The current UMTS/WCDMA spectrum allocation splits into ten operating bands. Operating band I, also known as WCDMA 2100, is used mostly in Europe and Asia and covers 1920-1980 MHz on the uplink (UL) and 2110-2170 MHz on the downlink (DL). Operating band II, also known as WCDMA 1900, is used mainly in North America and covers 1850-1910 MHz UL and 1930-1990 MHz DL. Operating band III covers 1710-1785 UL and 1805-1880 MHz DL. Operating band IV is used in the United States of America and covers 1710-1755 MHz UL and 2110-2150 MHz DL. Operating band V is used in North America and Australia and covers 824-849 MHz UL and 869-894 MHz DL. Operating band VI is used in Japan and covers 830-840 MHz UL and 975-885 MHz DL. Operating band VII is designated as the global expansion band and covers 2500-2570 MHz UL and 2620-2690 MHZ DL. Operating band VIII covers 890-915 MHz UL and 935-960 MHz DL. Operating band IX is used in the United States and Japan and covers 1750-1785 MHz UL and 1845-1880 MHz DL. And operating band X covers 1710-1770 MHz UL and 2110-2170 MHz DL. WCDMA is planning to adopt new operating bands around 700 MHz next year.

LTE (Long Term Evolution) is a Super 3G technology designed to facilitate the introduction of 4G technology into the mobile communication world and to co-exist with UMTS/WCDMA and GSM/EDGE digital systems. Thus, LTE technology will be able to support both future and legacy (existing) frequency bands.

Efforts to design multi-band, multi-mode mobile phones have been underway. For example, mobile phones covering triple-band WCDMA and quad-band GSM/EDGE technologies with one antenna have been developed. However, as the number of frequency bands and standards accommodated by an electronic device increases, so does the complexity and cost of the RF front-end module architecture (also referred to in the art as front-end architecture) within the device. Conventional front-end architectures would require a large number of RF components to handle the numerous RF signal paths needed to cover all GSM/EDGE, WCDMA, and LTE frequency bands (e.g., one RF signal path for each frequency band). Competing with the increasing demands on the radio portion of the electronic device is the constant push for miniaturization of electronic devices to satisfy the convenience and desires of consumers. As such, the need for broader bandwidth capability and complete flexibility between mobile communication standards, coupled with the demand for smaller devices, creates problems insofar as providing a cost-effective, compact and high-performance RF front-end module in a electronic device.

### SUMMARY

In accordance with an aspect of the invention, a multi-band, multi-mode radio frequency (RF) front-end module is provided that is capable of operating in widely different frequency bands.

In accordance with another aspect of the invention, a multi-band, multi-mode RF front-end module is provided that is capable of operating in frequency bands located in at least one of the following regions: 700 megahertz (MHz), 850 MHz, 900 MHz, 1800 MHz, 1900 MHz, 2.1 gigahertz (GHz) or 2.4 GHz.

In accordance with yet another aspect of the invention, a multi-band, multi-mode RF front-end module is provided that is capable of operating according to different mobile communication standards.

In accordance with still another aspect of the invention, a multi-band, multi-mode RF front-end module is provided that is capable of operating according to at least one of the following standards: GSM, WCDMA, EDGE, or LTE.

According to an aspect of the invention, a multi-band, multi-mode RF front-end module includes a plurality of broadband power amplifiers and a plurality of transmit (TX) paths selectively connectible to respective broadband power amplifiers. The multi-band, multi-mode RF front-end module further includes a plurality of switches. One switch is selectively operable to couple one plurality of TX paths to one broadband power amplifier that is operable to amplify TX signals within one range of frequencies. A second switch is selectively operable to couple a second plurality of TX paths to a second broadband power amplifier that is operable to amplify TX signals within a second range of frequencies.

According to another aspect of the invention, the multi-band, multi-mode RF front-end module is operable in a first range of frequencies and a second range of frequencies. The first and second ranges of frequencies including at least one of from about 700 MHz to about 900 MHz, from about 1710 MHz to about 1910 MHz, or from about 1920 MHz to about 2570 MHz.

According to yet another aspect of the invention, the multi-band, multi-mode RF front-end module further includes a third switch that is selectively operable to couple a third plurality of TX paths to a third broadband power amplifier that is operable to amplify TX signals within a third range of frequencies.

According to still another aspect of the invention, the multi-band, multi-mode RF front-end module is operable in a third range of frequencies including at least one of from about 700 MHz to about 900 MHz, from about 1710 MHz to about 1910 MHz, or from about 1920 MHz to about 2570 MHz.

In accordance with another aspect, the multi-band, multi-mode RF front-end IS module further includes a plurality of bandpass filters that are operatively connected to respective TX paths. Each bandpass filter is configurable to reject unwanted signals on respective TX paths.

In accordance with yet another aspect, the multi-band, multi-mode RF front-end is fabricated on at least one integrated circuit.

In accordance with still another aspect, the multi-band, multi-mode RF front-end module further includes a plurality of duplexers configurable to isolate TX signals and receive (RX) signals, and a plurality of RX paths. Each of a number of the RX paths are operatively connected to a respective one of the duplexers. The multi-band, multi-mode RF front-end module also includes a second plurality of switches that are selectively operable to connect a respective one of the plurality of duplexers to a respective one of the plurality of TX paths.

According to another aspect of the present invention, the multi-band, multi-mode RF front-end module further includes an antenna switch, which includes an antenna port and a plurality of RX and/or TX ports. The antenna switch is selectively operable to connect the plurality of RX and/or TX ports to the antenna port. The plurality of RX and/or TX ports are operatively connected to respective RX and/or TX paths.

According to yet another aspect of the present invention, the multi-band, multi-mode RF front-end module further includes a plurality of matching networks configurable to minimize insertion loss. A number of the matching networks is operatively connected to respective TX paths and a remainder of the matching networks is operatively connected to respective RX paths.

According to still another aspect of the present invention, the multi-band, multi-mode RF front-end module includes matching networks that are adaptive matching networks.

In accordance with another aspect of the present invention, a multi-band, multi-mode radio circuit includes a multi-mode transceiver configurable to prepare signals for reception and/or transmission in accordance with a plurality of mobile communication standards. The multi-band, multi-mode radio circuit further includes the multi-band, multi-mode RF front-end module.

In accordance with yet another aspect of the present invention, the multi-band, multi-mode radio circuit is operable according to a plurality of mobile communication standards that include at least one of GSM, EDGE, WCDMA, or LTE.

In accordance with still another aspect of the present invention, an electronic device includes an antenna operable to receive and/or transmit signals and a digital processor configurable to control the first plurality of switches, the second plurality of switches and the antenna switch. The electronic device further includes a multi-mode transceiver configurable to prepare signals for reception and/or transmission in accordance with a plurality of mobile communication standards. The electronic device also includes the multi-band, multi-mode RF front-end module.

In accordance with yet another aspect, the electronic device is operable according to a plurality of mobile communication standards that includes at least one of GSM, EDGE, WCDMA, or LTE.

In accordance with still another aspect, the electronic device is a mobile telephone.

According to another aspect of the present invention, a multi-mode, multi-band RF front-end module includes a plurality of TX paths, a plurality of RX paths, at least one broadband power amplifier, and a plurality of switches. Each TX path is operatively connected to a respective one of a plurality of bandpass filters. The bandpass filters are configurable to reject unwanted signals on respective TX paths. Each of a number of RX paths are operatively connected to a respective one of a plurality of duplexers. The duplexers are configurable to isolate TX signals and RX signals. The at least one broadband power amplifier is operable to amplify TX signals within a range of frequencies. The multi-band, multi-mode RF front-end module also includes a plurality of switches. One switch is selectively operable to couple the plurality of TX paths to the at least one broadband power amplifier, and a second switch is selectively operable to couple the plurality of duplexers to the TX path selected by the one switch.

According to yet another aspect of the present invention, the multi-band, multi-mode RF front-end module further includes an antenna switch comprising an antenna port and a plurality of RX and/or TX ports. The antenna switch is selectively operable to connect the plurality of RX and/or TX ports to the antenna port. The plurality of RX and/or TX ports are operatively connected to respective RX and/or TX paths.

According to still another aspect, the multi-band, multi-mode RF front-end module further includes a plurality of matching networks configurable to minimize insertion loss. A number of the matching networks are operatively connected to respective TX paths and a remainder of the matching networks are operatively connected to respective RX paths.

In accordance with another aspect, the multi-band, multi-mode RF front-end module includes matching networks that are adaptive matching networks.

In accordance with still another aspect, the multi-band, multi-mode RF front-end module is operable in a range of frequencies including at least one of from about 700 MHz to about 900 MHz, from about 1710 MHz to about 1910 MHz, or from about 1920 MHz to about 2570 MHz.

In accordance with yet another aspect, the multi-mode, multi-band RF front-end module further includes a second plurality of TX paths, a second plurality of RX paths, a plurality of broadband power amplifiers, and a second plurality of switches. Each TX path is operatively connected to a respective one of a second plurality of bandpass filters. The bandpass filters are configurable to reject unwanted signals on respective TX paths. Each of a number of RX paths are operatively connected to a respective one of a second plurality of duplexers. The duplexers are configurable to isolate TX signals and RX signals. Each broadband power amplifier is operable to amplify TX signals within a respective one of a plurality of frequency ranges. The multi-band, multi-mode RF front-end module also includes a second plurality of switches. A number of switches are selectively operable to couple the second plurality of TX paths to a respective one of the plurality of broadband power amplifiers, and a remainder of the switches are selectively operable to couple a number of the second plurality of duplexers to a respective one of the second plurality of TX paths.

According to another aspect of the present invention, the multi-mode, multi-band IS RF front-end module is operable in a plurality of frequency ranges including at least one of from about 700 MHz to about 900 MHz, from about 1710 MHz to about 1910 MHz, or from about 1920 MHz to about 2570 MHz.

According to still another aspect, the multi-band, multi-mode RF front-end module is fabricated on at least one integrated circuit.

In accordance with another aspect of the present invention, a method of facilitating flexibility and broad bandwidth capability of a multi-band, multi-mode radio frequency (RF) front-end module is provided that includes transmitting a transmit (TX) signal within a first range of frequencies via a respective one of a plurality of TX paths. The method further includes, by using a switch, selectively coupling the plurality of TX paths to one broadband power amplifier operable to amplify TX signals within the first range of frequencies. The method also includes transmitting a second TX signal within a second range of frequencies via a respective one of a second plurality of TX paths. The method further includes, by using a second switch, selectively coupling the second plurality of TX paths to a second broadband power amplifier operable to amplify TX signals within the second range of frequencies.

In accordance with yet another aspect of the invention, the method provides that the first range of frequencies is at least one of from about 700 MHz to about 900 MHz, from about 1710 MHz to about 1910 MHz, or from about 1920 MHz to about 2570 MHz. The method also provides that the second range of frequencies is at least one of from about 700 MHz to about 900 MHz, from about 1710 MHz to about 1910 MHz, or from about 1920 MHz to about 2570 MHz.

In accordance with still another aspect, the method further includes transmitting a third TX signal within a third range of frequencies via a respective one of a third plurality of TX paths. The method also includes, by using a third switch, selectively coupling the third plurality of TX paths to a third broadband power amplifier operable to amplify TX signals within the third range of frequencies.

In accordance with another aspect, the method provides that the third range of frequencies is at least one of from about 700 MHz to about 900 MHz, from about 1710 MHz to about 1910 MHz, or from about 1920 MHz to about 2570 MHz.

According to another aspect of the present invention, a method of facilitating flexibility and broad bandwidth capability of a multi-band, multi-mode radio frequency (RF) front-end module is provided that includes transmitting a respective one of a plurality of transmit (TX) signals via a respective one of a plurality of TX paths. Each TX path is operatively connected to a respective one of a plurality of bandpass filters. The bandpass filters are configurable to reject unwanted signals on the respective TX paths. The method further includes receiving a respective one of a plurality of receive (RX) signals via a respective one of a plurality of RX paths. Each of a number of the RX paths is operatively connected to a respective one of a plurality of duplexers. The duplexers are configurable to isolate TX signals and RX signals. The method also includes, by using a first switch, selectively coupling the TX paths to a broadband power amplifier operable to amplify TX signals within a range of frequencies. The method further includes, by using a second switch, selectively coupling a respective one of the duplexers to the TX path selected by the first switch.

In accordance with another aspect, the method provides that the range of frequencies is at least one of from about 700 MHz to about 900 MHz, from about 1710 MHz to about 1910 MHz, or from about 1920 MHz to about 2570 MHz.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

FIG. 1 is a schematic block diagram of an RF front-end module architecture in accordance with an embodiment of the present invention;

FIG. 2 is a schematic view of a mobile telephone as an exemplary electronic device that includes an RF front-end module in accordance with an embodiment of the present invention;

FIG. 3 is a schematic block diagram of the mobile telephone of FIG. 2; and

FIG. 4 is a schematic diagram of a communications system in which the mobile telephone of FIG. 2 may operate.

### DETAILED DESCRIPTION OF EMBODIMENTS

The interchangeable terms “electronic equipment” and “electronic device” include portable radio communication equipment. The term “portable radio communication equipment,” which hereinafter may be referred to as a “mobile radio terminal,” includes all equipment such as mobile telephones, pagers, communicators, electronic organizers, personal digital assistants (PDAs), smartphones, portable communication apparatus or the like.

In the present document, embodiments are described primarily in the context of a mobile telephone. It will be appreciated, however, that the exemplary context of a mobile telephone is not the only context and the context may relate to any type of appropriate electronic equipment, examples of which include a media player, a PDA, a gaming device and a computer.

In the present invention, a front-end module useful, for example, in a radio circuit or an electronic device, e.g., as was mentioned just above, is operable over a number of frequency bands and mobile communication standards. Using a combination of broadband power amplifiers, duplexers, bandpass filters, matching networks, and selectively operable switches, the front-end module may operate in respective bands and according to respective standards. In an exemplary embodiment, the front-end module is coupled between an antenna and a multi-mode transceiver to provide coupling there between of signals of a character corresponding to respective bands and standards.

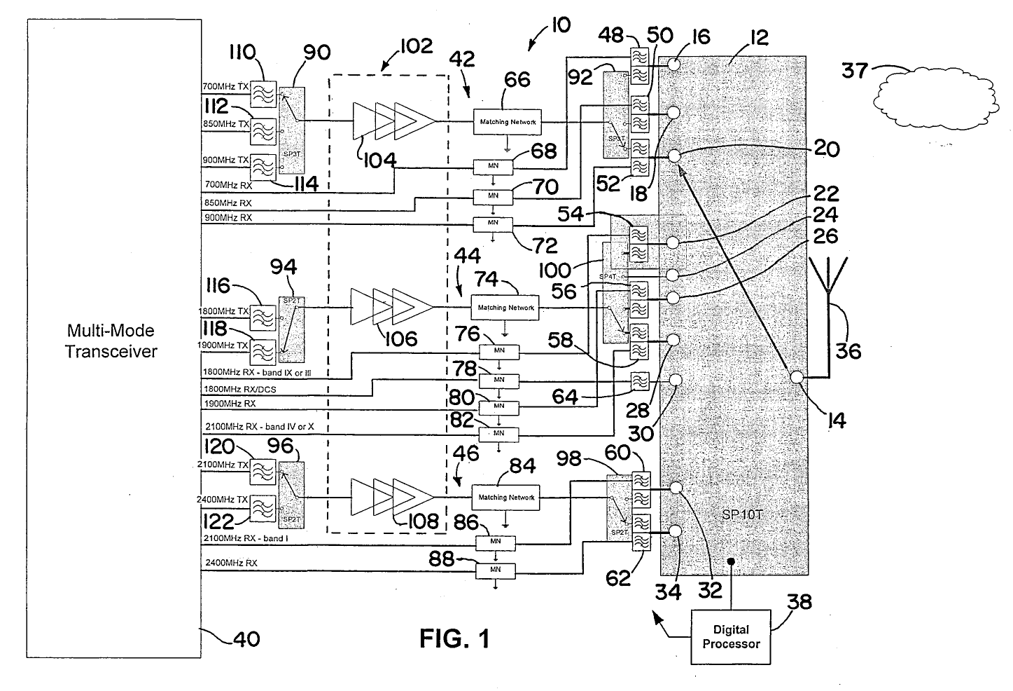

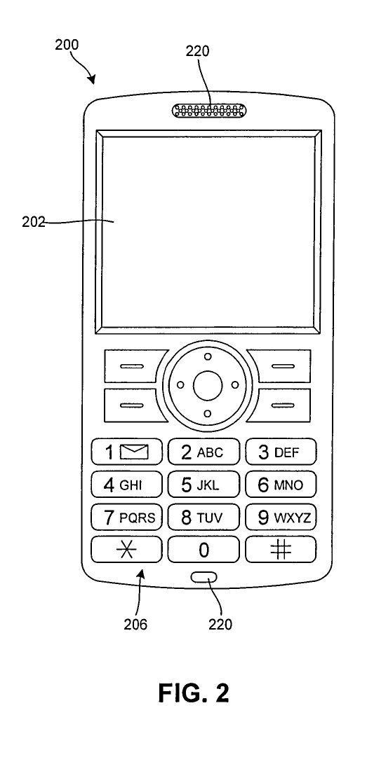

FIG. 1 is an exemplary architecture for a radio frequency (RF) front-end module 10 to be included in an electronic device 11 (to be discussed with respect to FIG. 2 below) in accordance with an exemplary embodiment of the present invention. The exemplary architecture uses components efficiently to tend to minimize the number used to provide radio coverage across multiple standards (e.g., WCDMA, GSM, EDGE, LTE) and across multiple frequency bands (e.g., four-band GSM/EDGE, twelve-band WCDMA), while still providing high isolation between bands, low insertion loss, and high receiver performance.

The RF front-end module 10 includes an SP10T (single-pole, ten-throw) switch 12 with an antenna port 14 and ten RX (receive) and/or TX (transmit) ports 16, 18, 20, 22, 24, 26, 28, 30, 32 and 34. Each RX and/or TX port is associated with respective frequency band(s) and mobile communication standard(s). An antenna 36 of the electronic device 11 is configured to receive an inbound signal from, or transmit an outbound signal to, a communication network 37 (also discussed with respect to FIG. 4 below), such as a mobile telephone network. In the exemplary embodiment, the same antenna 36 is used for all communication standards and all frequency bands. The communication network 37 determines which mobile communication standard and frequency band to use based on, e.g., coverage, capacity, service requirements, etc. The communication network 37 sends this standard and frequency information to the RF front-end module 10 via the antenna 36.

A digital processor 38 included in the electronic device 11 retrieves the communication standard and frequency information from the antenna 36 and presents this information in the form of control signals to the components of the RF front-end module 10 that are associated with the network's chosen standard and frequency. The control signals direct the components to connect to each other so as to form a signal path between the antenna 36 and a multi-mode transceiver 40 (to be discussed in more detail below) of the electronic device 11. In this manner, the digital processor 38 directs the flow of signal “traffic” throughout the RF front-end module 10. For example, the digital processor 38 controls the SP10T switch 12 by directing which RX and/or TX port should be connected to the antenna port 14 for a given receive or transmit signal. Each RX and/or TX port of the SP10T switch 12 corresponds to at least one RX and/or TX path of the RF front-end module architecture 10. In such manner, the digital processor 38 controls which RX and/or TX path will carry a given signal within the RF front-end module 10.

In the exemplary embodiment, the RF front-end module architecture 10 is divided into three sections: a low frequency section 42, a middle frequency section 44 and a high frequency section 46. By separating the RX and/or TX paths into low, middle and high frequency sections 42, 44 and 46, the RF front-end module 10 minimizes the RF interference between different frequency paths.

The low frequency section 42 includes RX/TX ports 16, 18 and 20. The low frequency section 42 also includes three RX paths associated with a respective one of RX/TX ports 16, 18 and 20. The low frequency section 42 further includes three TX paths also associated with a respective one of RX/TX ports 16, 18 and 20. The RX path and TX path associated with RX/TX port 16 both carry signals in a range around the 700 MHz frequency band. The 700 MHz band may cover, e.g., future WCDMA operating bands in the 700 MHz range. The RX path and TX path associated with RX/TX port 18 both carry signals in a range around the 850 MHz frequency band. The 850 MHz band may cover, e.g., GSM 850 (also known as GSM 800). The 850 MHz band also may cover, e.g., WCDMA operating bands V and/or VI. Lastly, the RX path and TX path associated with RX/TX port 20 both carry signals in a range around the 900 MHz frequency band. The 900 MHz band may cover, e.g., GSM 900. The 900 MHz band also may cover, e.g., WCDMA operating band VIII.

The middle frequency section 44 includes RX/TX ports 22, 26 and 28. The middle frequency section also includes TX port 24 and RX port 30. The middle frequency section 44 further includes four RX paths associated with a respective one of ports 22, 26, 28 and 30. The middle frequency section 44 also includes four TX paths associated with a respective one of ports 22, 24, 26 and 28. The RX path and TX path associated with RX/TX port 22 both carry signals in a range around the 1800 MHz frequency band. The 1800 MHz frequency band may cover, e.g., WCDMA operating bands III and/or IX. The TX path associated with TX port 24 carries signals in a range around both the 1800 MHz frequency band and the 1900 MHz frequency band. TX port 24 handles, e.g., GSM 1800 and/or GSM 1900. The RX path and TX path associated with RX/TX port 26 both carry signals in a range around the 1900 MHz frequency band. The 1900 MHz frequency band may cover, e.g., WCDMA 1900. The RX path associated with RX/TX port 28 carries signals in a range around the 2100 MHz frequency band. The TX path associated with RX/TX port 28 carries signals in a range around the 1800 MHz frequency band. RX/TX port 28 handles, e.g., WCDMA operating bands IV and/or X. Lastly, the RX path associated with RX port 30 carries signals in a range around the 1800 MHz frequency band. RX port 30 handles, e.g., GSM 1800.

The high frequency section 46 includes RX/TX ports 32 and 34. The high frequency section 46 also includes two RX paths associated with a respective one of RX/TX ports 32 and 34. The high frequency section 46 further includes two TX paths associated with a respective one of RX/TX ports 32 and 34. The RX path and TX path associated with RX/TX port 32 both carry signals in a range around the 2100 MHz frequency band. The 2100 MHz frequency band may cover, e.g., WCDMA operating band I. The RX path and TX path associated with RX/TX port 34 both carry signals in a range around the 2400 MHz frequency band. The 2400 MHz frequency band may cover, e.g., WCDMA operating band VII.

LTE supported frequency bands will include all existing GSM/EDGE and WCDMA frequency bands; therefore, any of the above ports and paths may convey LTE signals within respective frequency bands.

The RX/TX ports 16, 18, 20, 22, 26, 28, 32 and 34 are connected to duplexers 48, 50, 52, 54, 56, 58, 60 and 62, respectively, for isolating receive signals and transmit signals from each other. As is known in the art, the use of a duplexer allows a transceiver to receive and transmit signals noise-free over one common antenna. Each duplexer in the RF front-end module 10 is designed to operate within the frequency band associated with the corresponding RX/TX port. The frequency range of each duplexer in the present invention does not exceed the frequency separation between the associated RX and TX paths. In this manner, the duplexers may filter out noise on associated TX paths occurring within the frequency range of associated RX paths. Furthermore, each duplexer in the RF front-end module 10 provides high isolation to prevent desensitization of the receiver portion of the multi-mode transceiver 40. High isolation enhances the performance of the RF front-end module 10 by rejecting unwanted in-band signals, which, if allowed to pass through the duplexer, may lead to “dropped calls.”

In the exemplary embodiment, TX port 24 and RX port 30 are not connected to duplexers in order to avoid cross-interference between signals in certain circumstances, for example between the GSM 1900 TX band and the GSM 1800 RX band. As is known in the art, the GSM 1900 TX band may overlap with the GSM 1800 RX band. As a result, transmit and receive signals having a frequency within the overlapping range between these bands may be coupled and/or bonded together if the duplexer cannot provide high isolation. In order to provide good sensitivity at the receiver portion of the multi-mode transceiver 40, RX port 30 is a full receiving port and is connected to a bandpass filter 64, rather than to a duplexer. The bandpass filter 64 may be of any type including, e.g., SAW (surface acoustic wave), BAW (bulk acoustic wave), FBAR (thin-film bulk acoustic resonators), etc. Similarly, TX port 24 is a full transmit port and no duplexer or filter is connected to this port. In this manner, the RF front-end module 10 provides high isolation even at the GSM 1900 TX and GSM 1800 RX bands.

Each RX and/or TX path is connected to a respective one of the matching networks 66, 68, 70, 72, 74, 76, 78, 80, 82, 84, 86 and 88. The more input/output ports in a switch, the more isolation and insertion loss issues arise. The matching networks of RF front-end module 10 function to minimize the effect of the insertion loss contributed by SP10T switch 12, as well as SP3T (single pole three throws) switch 90, SP3T switch 92, SP2T (single pole two throws) switch 94, SP2T switch 96, SP2T switch 98 and SP4T (single pole four throws) switch 100. The matching networks of the present invention match the impedance of each RX and/or TX path to that of the antenna 36, for example, which improves the TIS/TRP (Total Isotropic Sensitivity/Total Radiated Power) measurements of the antenna 36. For the sake of brevity, the matching networks will not be described in greater detail. However, it will be apparent to a person having ordinary skill in the art of RF design how to implement the matching networks. In the exemplary embodiment, the matching networks are fixed matching networks. A fixed matching network matches the impedance of the RX/ and/or TX paths to a constant value, such as the impedance of a capacitor or other component within the antenna 36. In another embodiment, the matching networks may be adaptive matching networks. An adaptive matching network allows dynamic optimization of the load impedance by tuning the matching conditions for the antenna 36 in order to provide high performance at varying output powers and antenna conditions. Thus, an adaptive matching network may be modified as the antenna's performance changes.

The digital processor 38 controls SP3T switch 90, SP2T switch 94 and SP2T switch 96 by directing which associated TX path should be connected to a power amplifier (PA) block 102. In the exemplary embodiment, the PA block 102 includes a low frequency PA 104, a middle frequency PA 106 and high frequency PA 108 all in one module. PAs 104, 106 and 108 are broadband power amplifiers. The TX paths in the low frequency section 42 are selectively connectible to the low frequency PA 104, which is configured to amplify signals having frequencies between about 700 MHz to about 900 MHz. The TX paths in the middle frequency section 44 are selectively connectible to the middle frequency PA 106, which is configured to amplify signals having frequencies between about 1710 MHz to about 1910 MHz. And the TX paths in the high frequency section 46 are selectively connectible to the high frequency PA 108, which is configured to amplify signals having frequencies between about 1920 MHz to about 2570 MHz. In another embodiment, power amplifiers 104, 106 and 108 are placed at the output of switches 90, 94 and 96, respectively, rather than being provided in one module (as shown).

Bandpass filters are connected to the input side of switches 90, 94 and 96 to reject out-of-band signals in the TX path (e.g., to filter out noise). The bandpass filters of the present invention also increase isolation between transmit and receive signals, as well as signals having non-cellular frequency bands (e.g., peripheral radio signals). Bandpass filter 110 is configured to allow signals within the 700 MHz frequency range and is connected to the 700 MHz TX path. Bandpass filter 112 is configured to allow signals within the 850 MHz frequency range and is connected to the 850 MHz TX path. And bandpass filter 114 is configured to allow signals within the 900 MHz frequency range and is connected to the 900 MHz TX path. The outputs of bandpass filters 110, 112 and 114 are connected to the input side of SP3T switch 90. Bandpass filter 116 is configured to allow signals within the 1800 MHz frequency range and is connected to the 1800 MHz TX path. And bandpass filter 118 is configured to allow signals within the 1900 MHz frequency range and is connected to the 1900 MHz TX path. The outputs of bandpass filters 116 and 118 are connected to the input side of SP2T switch 94. Bandpass filter 120 is configured to allow signals within the 2100 MHz frequency range and is connected to the 2100 MHz TX path. And bandpass filter 122 is configured to allow signals within the 2400 MHz frequency range and is connected to the 2400 MHz TX path. The outputs of bandpass filters 120 and 122 are connected to the input side of SP2T switch 96. In the exemplary embodiment, the bandpass filters may be of any type including, e.g., SAW, BAW, FBAR, etc.

The multi-mode transceiver 40 is configured to send and receive signals according to different communication standards including, GSM, EDGE, WCDMA, LTE, etc. The multi-mode transceiver 40 may include an RF ASIC (application specific integrated circuit) (not shown) for carrying out the transmit and receive functions of the transceiver 40. The digital processor 38 controls the multi-mode transceiver 40 by directing the transceiver 40 to operate according to the communication standard and frequency chosen by the communication network 37. Each communication standard may require a specific modulation technique for providing a signal that can be easily accommodated by the communication network 37. The modulation process includes translating a message signal to a new spectral location by varying certain parameters of the signal, such as its amplitude, phase and/or frequency, so that a modulated signal conveys the message or information. For the sake of brevity, the specific modulation technique used for each mobile communication standard will not be discussed in greater detail. However, it will be apparent to a person having ordinary skill in the art of mobile communication systems how to implement the required modulation technique for each communication standard.

Based on the frequency and standard information received from the digital processor 38, the multi-mode transceiver 40 applies the appropriate modulation technique to a given signal. In the exemplary embodiment, the multi-mode transceiver 40 applies the required modulation to all signals, regardless of whether WCDMA, GSM/EDGE or LTE is being used by the communication network 37. According to the exemplary embodiment, PAs 104, 106 and 108 are all broadband power amplifiers and may be either linear or non-linear. In another embodiment, the multi-mode transceiver 40 applies either linear modulation or small signal polar modulation to GSM/EDGE signals and applies linear modulation to WCDMA signals. In this embodiment, PAs 104, 106 and 108 are all linear broadband power amplifiers. In yet another embodiment, the multi-mode transceiver 40 applies open loop polar modulation to GSM/EDGE signals and linear modulation to WCDMA signals. In this embodiment, PAs 104 and 106 may operate as either saturated broadband power amplifiers for GSM/EDGE signals or as linear broadband power amplifiers for WCDMA signals. PA 108 is a linear broadband power amplifier for all signals.

An example of the operation of the RF front-end module 10 will now be described. As mentioned above, the digital processor 38 controls all switches in the RF front-end module 10 and thereby directs traffic within the RF front-end module. In this exemplary operation, the communication network 37 sends a signal to the antenna 36 containing information that the network 37 is operating in a WCDMA frequency band in the 700 MHz range (e.g., the antenna 36 may send and receive signals within this operating band). Based on the information from the network 37, the digital processor 38 sends a control signal to switches 12, 90 and 92 that directs the switches to connect the 700 MHz TX and RX paths from the antenna 36 to the multi-mode transceiver 40. In response, SP10T switch 12 connects the antenna port 14 to RX/TX port 16. Switch 92 connects matching network 66 to RX/TX port 16. And switch 90 connects bandpass filter 110 to low frequency PA 104. The digital processor 38 also directs the multi-mode transceiver 40 to send and receive signals using a modulation technique appropriate for WCDMA systems.

Continuing with the exemplary operation, in the send mode (e.g., transmitting a signal via the antenna 36 to the communication network 37), the multi-mode transceiver 40 modulates a transmit signal using linear modulation (because WCDMA applies) and outputs the transmit signal via the 700 MHz TX path. The transmit signal is filtered through bandpass filter 110, and SP3T switch 90 connects the transmit signal to low frequency PA 104 for amplification. Matching network 66 matches the impedance of the transmit signal to that of the antenna 36. SP3T switch 92 connects the transmit signal to duplexer 48 for isolating the transmit signal from any receive signals. SP10T switch 12 connects RX/TX port 16 to the antenna port 14, allowing the transmit signal to reach the antenna 36. Finally, the antenna 36 transmits the signal over a WCDMA frequency band in the 700 MHz range to the communication network 37.

Still continuing with the exemplary operation of RF front-end module 10, in the receive mode (e.g., receiving a signal from the communication network 37 via the antenna 36), antenna 36 receives a signal in the WCDMA 700 MHz frequency range from the communication network 37. SP10T switch 12 connects antenna port 14 to RX/TX port 16. The received signal passes through duplexer 48 for isolating the received signal from any transmit signals. Matching network 68 matches the impedance of the receive signal to that of the antenna 36. Finally, the received signal enters the multi-mode transceiver 40, where the transceiver demodulates the received signal accordingly.

The RF front-end module 10 may be fabricated on one or more integrated circuits (ICs). The various components listed above and included in the RF front-end module 10 may be fabricated on the same IC or on one or more separate but connected ICs. All switches included in the RF front-end module 10 may be based on any type of technology including, e.g., GaAs, pHEMT, CMOS, MEMS, etc.

In the exemplary embodiment, the use of switches 90, 94 and 96 in combination with the power amplifier block 102 reduces the number of components included in the RF front-end module 10. In contrast, conventional RF front-end modules require a power amplifier for each TX path. The present invention reduces the number of power amplifiers by using broadband power amplifiers that can amplify signals having a wide range of frequency bands, whereas simple power amplifiers are limited to amplifying signals having a narrow range of frequencies. Switches 92, 100 and 98 also help keep the number of components to a minimum by facilitating common RX and/or TX paths for GSM/EDGE, WCDMA and/or LTE signals. In contrast, conventional RF front-end modules place GSM/EDGE and WCDMA signals on separate paths, requiring a corresponding number of respective RX and/or TX ports at the antenna switching module. Reducing the number of RX and/or TX paths in the RF front-end module 10 also helps reduce the area of the associated RF ASIC (included in multi-mode transceiver 40) because fewer signal paths means fewer pin connections are required for the RF ASIC. High isolation of transmit signals is made possible by using both bandpass filters and duplexers on the TX paths. Also, high receiver performance is achieved by not co-banding GSM 1800 RX path with the corresponding WCDMA RX path. Furthermore, while it is well known that introducing more input/output (I/O) ports normally increases the insertion loss of a radio circuit, the use of matching networks counteracts this affect and allows the RF front-end module 10 to include SP10T switch 12 without sacrificing receiver performance. The matching networks operate to minimize any insertion loss introduced by, for example, the high number of switches used in the present invention. In this manner, the present invention is able to minimize the number of components used and still provide high receiver performance with low insertion loss and high isolation.

In another embodiment, the electronic device may provide full receiving and transmitting diversity by providing two radio circuit branches. Each branch would include an antenna, an RF front-end module, and a multi-mode transceiver. Furthermore, each radio circuit would be capable of both receiving and transmitting signals. Also, each radio circuit branch may be connected to separate digital processors. Because the present invention tends to efficiently minimize the architecture for an RF front-end module, full receiving and transmitting diversity may be achieved by duplicating the same architecture without affecting space constraints of the electronic device.

In still another embodiment, the RX port 30 could be removed, along with the 1800 MHz DCS path. In such embodiment, the TX path and RX path associated with RX/TX port 22 would both carry signals having a frequency within a range around the 1800 MHz frequency band. This 1800 MHz frequency band would include GSM 1800 and/or WCDMA operating bands IX or III. In this case, duplexer 54 should have low insertion loss and high isolation (35 dB or better) in order to provide good sensitivity for the receiver portion of the multimode transceiver 40.

In yet another embodiment, the architecture of the RF front-end module 10 may be scaled down to support any combination of frequency bands and communication standards. If fewer frequency bands are to be supported by the RF front-end module, the SP10T switch 12 may be replaced with a smaller switch, such as an SP9T (single pole nine throws) switch, an SP8T (single pole eight throws) switch, etc., depending on the number of frequency bands being supported. In the present invention, RF front-end module 10 supports at least 14 existing frequency bands (10 WCDMA bands and 4 GSM bands) and a plurality of future frequency bands in the 700 MHz range for WCDMA. If, for example, the RF front-end module were to support only the 14 existing frequency bands, RX/TX port 16 would not longer be needed and the SP10T switch could be replaced with an SP9T switch. In this case, switch 90 could be replaced with an SP2T switch and switch 92 could be replaced with an SP2T switch as well to accommodate for the fewer number of signal paths. Also in this case, low frequency PA 104 could be replaced with a broadband power amplifier that amplifies signals having a frequency between about 800 MHz and about 900 Mhz. In this manner, for example, the RF front-end module 10 may be scaled down to support any combination of frequency bands and communication standards.

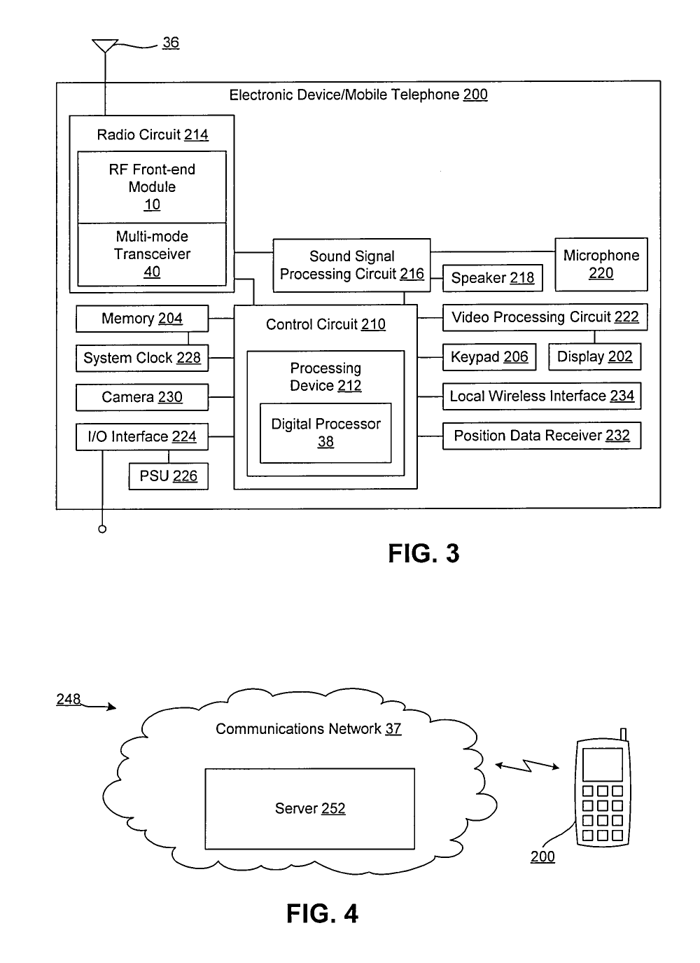

Referring now to FIGS. 2 and 3, an electronic device 200 including the RF front-end module 10 is shown. The electronic device 200 may be the same as the electronic device 11 discussed above with respect to FIG. 1. The electronic device of the illustrated embodiment is a mobile telephone and will be referred to as the mobile telephone 200. In FIG. 2, the mobile telephone 200 is shown as having a “brick” or “block” form factor housing, but it will be appreciated that other housing types may be utilized, such as a “flip-open” form factor (e.g., a “clamshell” housing) or a slide-type form factor (e.g., a “slider” housing). For the sake of brevity, many features of the mobile telephone 200 will not be described in great detail.

The mobile telephone 200 may include a display 202. The display 202 displays information to a user such as operating state, time, telephone numbers, contact information, various menus, etc., that enable the user to utilize the various features of the mobile telephone 200. The display 202 also may be used to visually display content received by the mobile telephone 200 and/or retrieved from a memory 204 (FIG. 3) of the mobile telephone 200, such as images, video and other graphics.

A keypad 206 provides for a variety of user input operations. For example, the keypad 206 may include alphanumeric keys for allowing entry of alphanumeric information such as telephone numbers, phone lists, contact information, notes, text, etc. In addition, the keypad 206 may include special function keys such as a “call send” key for initiating or answering a call, and a “call end” key for ending or “hanging up” a call. Special function keys also may include menu navigation and select keys to facilitate navigating through a menu displayed on the display 202 and/or audiovisual content playback keys to start, stop and pause playback, skip or repeat tracks, and so forth. Other keys associated with the mobile telephone 200 may include a volume key, an audio mute key, an on/off power key, a web browser launch key, a camera key, etc. Keys or key-like functionality also may be embodied as a touch screen associated with the display 202.

The mobile telephone 200 includes call circuitry that enables the mobile telephone 200 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 200 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “SMS,” which stands for simple message service. Similarly, a multimedia message is commonly referred to by some as “MMS,” which stands for multimedia message service. Processing data may include storing the data in the memory 204, executing applications to allow user interaction with the data, displaying video and/or image content associated with the data, outputting audio sounds associated with the data, and so forth.

FIG. 3 represents a functional block diagram of the mobile telephone 200. For the sake of brevity, many features of the mobile telephone 200 will not be described in great detail. The mobile telephone 200 includes a primary control circuit 210 that is configured to carry out overall control of the functions and operations of the mobile telephone 200. The control circuit 210 may include a processing device 212, such as a central processing unit (CPU), microcontroller or microprocessor. The processing device 212 executes code stored in a memory (not shown) within the control circuit 210 and/or in a separate memory, such as the memory 204, in order to carry out operation of the mobile telephone 200. The memory 204 may be, for example, one or more of a buffer, a flash memory, a hard drive, a removable media, a volatile memory, a non-volatile memory, a random access memory (RAM), or other suitable device. In a typical arrangement, the memory 204 may include a non-volatile memory (e.g., a NAND or NOR architecture flash memory) for long-term data storage and a volatile memory that functions as a system memory for the control circuit 210. The volatile memory may be a RAM implemented with synchronous dynamic random access memory (SDRAM), for example. The memory 204 may exchange data with the control circuit 210 over a data bus. Accompanying control lines and an address bus between the memory 204 and the control circuit 210 also may be present.

In addition, the processing device 212 may include the digital processor 38 for processing communication functions. As described above with respect to FIG. 1, the digital processor 38 receives information from the communication network 37 regarding which communication standard and frequency band is being used for a receive signal or is available for use for a transmit signal. The digital processor 38 may execute code to implement these communication functions. It will be apparent to a person having ordinary skill in the art of computer programming, and specifically in application programming for mobile telephones or other electronic devices, how to program a mobile telephone 200 to operate and carry out logical functions associated with these communication functions. Accordingly, details as to specific programming code have been left out for the sake of brevity. Also, while the stated communication functions are executed by the processing device 212 in accordance with an exemplary embodiment of the present invention, such functionality could also be carried out via dedicated hardware or firmware, or some combination of hardware, firmware and/or software.

Continuing to refer to FIGS. 2 and 3, the mobile telephone 200 includes the antenna 36 coupled to a radio circuit 214. The radio circuit 214 includes the RF front-end module 10 and the multi-mode transceiver 40 for transmitting and receiving signals via the antenna 36. The radio circuit 214 may be configured to operate in a mobile communications system and may be used to send and receive data and/or audiovisual content. As mentioned above, transceiver modes for interaction with a mobile radio network and/or broadcasting network include, but are not limited to, GSM, WCDMA, EDGE, LTE, Bluetooth, WLAN, WiMax, DVB-H, etc., as well as advanced versions of these standards. It will be appreciated that the antenna 36 and the radio circuit 214 may represent one or more than one RF front-end module 10, multi-mode transceiver 40 and/or antenna 36.

The mobile telephone 10 further includes a sound signal processing circuit 216 for processing audio signals transmitted by and received from the radio circuit 214. Coupled to the sound processing circuit 216 are a speaker 218 and a microphone 220 that enable a user to listen and speak via the mobile telephone 200. The radio circuit 214 and sound processing circuit 216 are each coupled to the control circuit 210 so as to carry out overall operation. Audio data may be passed from the control circuit 210 to the sound signal processing circuit 216 for playback to the user. The audio data may include, for example, audio data from an audio file stored by the memory 204 and retrieved by the control circuit 210, received audio data such as in the form of streaming audio data from a mobile radio service, or the voice of a caller. The sound processing circuit 216 may include any appropriate buffers, decoders, amplifiers and so forth.

The display 202 may be coupled to the control circuit 210 by a video processing circuit 222 that converts video data to a video signal used to drive the display 202. The video processing circuit 222 may include any appropriate buffers, decoders, video data processors and so forth. The video data may be generated by the control circuit 210, retrieved from a video file that is stored in the memory 204, derived from an incoming video data stream that is received by the radio circuit 214 or obtained by any other suitable method.

The mobile telephone 200 may further include one or more I/O interface(s) 224. The I/O interface(s) 224 may be in the form of typical mobile telephone I/O interfaces and may include one or more electrical connectors. As is typical, the I/O interface(s) 224 may be used to couple the mobile telephone 200 to a battery charger to charge a battery of a power supply unit (PSU) 226 within the mobile telephone 200. In addition, or in the alternative, the I/O interface(s) 224 may serve to connect the mobile telephone 200 to a headset assembly (e.g., a personal handsfree (PHF) device) that has a wired interface with the mobile telephone 200. Further, the I/O interface(s) 224 may serve to connect the mobile telephone 200 to a personal computer or other device via a data cable for the exchange of data. The mobile telephone 200 may receive operating power via the I/O interface(s) 224 when connected to a vehicle power adapter or an electricity outlet power adapter. The PSU 226 may supply power to operate the mobile telephone 200 in the absence of an external power source.

The mobile telephone 200 also may include a system clock 228 for clocking the various components of the mobile telephone 200, such as the control circuit 210 and the memory 204. The mobile telephone 200 also may include a camera 230 for taking digital pictures and/or movies. Image and/or video files corresponding to the pictures and/or movies may be stored in the memory 204. The mobile telephone 200 further may include a position data receiver 232, such as a global positioning system (GPS) receiver, Galileo satellite system receiver or the like. The position data receiver 232 may be involved in determining the location of the mobile telephone 200.

The mobile telephone 200 also may include a local wireless interface 234, such as an infrared transceiver and/or an RF interface (e.g., a Bluetooth interface), for establishing communication with an accessory, another mobile radio terminal, a computer or another device. For example, the local wireless interface 234 may operatively couple the mobile telephone 200 to a headset assembly (e.g., a PHF device) in an embodiment where the headset assembly has a corresponding wireless interface.

With additional reference to FIG. 4, the mobile telephone 200 may be configured to operate as part of a communications system 248. The system 248 may include the communications network 37 having a server 252 (or servers) for managing calls placed by and destined to the mobile telephone 200, transmitting data to the mobile telephone 200, transmitting communication standard and frequency band information to the mobile telephone 200 and carrying out any other support functions. The server 252 communicates with the mobile telephone 200 via a transmission medium. The transmission medium may be any appropriate device or assembly, including, for example, a communications tower (e.g., a cell tower), another mobile telephone, a wireless access point, a satellite, etc. Portions of the network 37 may include wireless transmission pathways. The network 37 may support the communications activity of multiple mobile telephones 200 and other types of end user devices. As will be appreciated, the server 252 may be configured as a typical computer system used to carry out server functions and may include a processor configured to execute software containing logical instructions that embody the functions of the server 252 and a memory to store such software.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A multi-band, multi-mode radio frequency (RF) front-end module, comprising:
a plurality of broadband power amplifiers;
a plurality of transmit (TX) paths selectively connectible to respective broadband power amplifiers; and
a plurality of switches, one switch selectively operable to couple one plurality of TX paths to one broadband power amplifier operable to amplify TX signals within one range of frequencies, and a second switch selectively operable to couple a second plurality of TX paths to a second broadband power amplifier operable to amplify TX signals within a second range of frequencies.

2. The multi-mode, multi-band RF front-end module of claim 1, wherein
the first range of frequencies is at least one of from about 700 MHz to about 900 MHz, from about 1710 MHz to about 1910 MHz, or from about 1920 MHz to about 2570 MHz; and
the second range of frequencies is at least one of from about 700 MHz to about 900 MHz, from about 1710 MHz to about 1910 MHz, or from about 1920 MHz to about 2570 MHz.

3. The multi-band, multi-mode RF front-end module of claim 1, further comprising:
a third switch selectively operable to couple a third plurality of TX paths to a third broadband power amplifier operable to amplify TX signals within a third range of frequencies.

4. The multi-band, multi-mode RF front-end module of claim 3, wherein the third range of frequencies is at least one of from about 700 MHz to about 900 MHz, from about 1710 MHz to about 1910 MHz, or from about 1920 MHz to about 2570 MHz.

5. The multi-band, multi-mode RF front-end module of claim 1, further comprising:
a plurality of bandpass filters operatively connected to respective TX paths, each bandpass filter configurable to reject unwanted signals on respective TX paths;
a plurality of duplexers configurable to isolate TX signals and receive (RX) signals;
a plurality of RX paths, each of a number of the RX paths being operatively connected to a respective one of the duplexers; and
a second plurality of switches selectively operable to connect a respective one of the plurality of duplexers to a respective one of the plurality of TX paths.

6. The multi-band, multi-mode RF front-end module of claim 5, further comprising:
an antenna switch comprising an antenna port and a plurality of RX and/or TX ports, the antenna switch being selectively operable to connect the plurality of RX and/or TX ports to the antenna port, wherein the plurality of RX and/or TX ports are operatively connected to respective RX and/or TX paths; and
a plurality of matching networks configurable to minimize insertion loss, a number of the matching networks being operatively connected to respective TX paths and a remainder of the matching networks being operatively connected to respective RX paths.

7. The multi-band, multi-mode RF front-end module of claim 6, wherein the matching networks are adaptive matching networks.

8. An electronic device, comprising:
an antenna operable to receive and/or transmit signals;
a digital processor configurable to control the first plurality of switches, the second plurality of switches, and the antenna switch;
a multi-mode transceiver configurable to prepare signals for reception and/or transmission in accordance with a plurality of mobile communication standards; and
the multi-band, multi-mode RF front-end module of claim 6.

9. The electronic device of claim 8, wherein the plurality of mobile communication standards comprises at least one of GSM, EDGE, WCDMA, or LTE.

10. The electronic device of claim 8, wherein the electronic device is a mobile telephone.

11. A multi-mode, multi-band radio frequency (RF) front-end module, comprising:
a plurality of transmit (TX) paths, each TX path being operatively connected to a respective one of a plurality of bandpass filters, wherein the bandpass filters are configurable to reject unwanted signals on respective TX paths;
a plurality of receive (RX) paths, each of a number of the RX paths being operatively connected to a respective one of a plurality of duplexers, wherein the duplexers are configurable to isolate TX signals and RX signals;
at least one broadband power amplifier operable to amplify TX signals within a range of frequencies; and
a plurality of switches, one switch selectively operable to couple the plurality of TX paths to the at least one broadband power amplifier, and a second switch selectively operable to couple the plurality of duplexers to the TX path selected by the one switch.

12. The multi-band, multi-mode RF front-end module of claim 11, further comprising:
an antenna switch comprising an antenna port and a plurality of RX and/or TX ports, the switch being selectively operable to connect the plurality of RX and/or TX ports to the antenna port, wherein the plurality of RX and/or TX ports are operatively connected to respective RX and/or TX paths; and
a plurality of matching networks configurable to minimize insertion loss, a number of the matching networks being operatively connected to respective TX paths and a remainder of the matching networks being operatively connected to respective RX paths.

13. The multi-band, multi-mode RF front-end module of claim 12, wherein the matching networks are adaptive matching networks.

14. The multi-mode, multi-band RF front-end module of claim 11, wherein the range of frequencies is at least one of from about 700 MHz to about 900 MHz, from about 1710 MHz to about 1910 MHz, or from about 1920 MHz to about 2570 MHz.

15. The multi-mode, multi-band RF front-end module of claim 12, further comprising:
a second plurality of TX paths, each TX path being operatively connected to a respective one of a second plurality of bandpass filters, wherein the bandpass filters are configurable to reject unwanted signals on respective TX paths;
a second plurality of RX paths, each of a number of the RX paths being operatively connected to a respective one of a second plurality of duplexers, wherein the duplexers are configurable to isolate TX signals and RX signals;
a plurality of broadband power amplifiers, each broadband power amplifier operable to amplify TX signals within a respective one of a plurality of frequency ranges; and
a second plurality of switches, a number of the switches selectively operable to couple a number of the second plurality of TX paths to a respective one of the plurality of broadband power amplifiers, and a remainder of the switches selectively operable to couple a number of the second plurality of duplexers to a respective one of the second plurality of TX paths.

16. The multi-mode, multi-band RF front-end module of claim 15, wherein the plurality of frequency ranges includes at least one of from about 700 MHz to about 900 MHz, from about 1710 MHz to about 1910 MHz, or from about 1920 MHz to about 2570 MHz.

17. An electronic device, comprising:
an antenna operable to receive and/or transmit signals;
a digital processor configurable to control the plurality of switches and the antenna switch;
a multi-mode transceiver configurable to prepare signals for reception and/or transmission in accordance with a plurality of mobile communication standards; and
the multi-band, multi-mode RF front-end module of claim 12.

18. The electronic device of claim 17, wherein the plurality of mobile communication standards comprises at least one of GSM, EDGE, WCDMA, or LTE.

19. The electronic device of claim 17, wherein the electronic device is a mobile telephone.

20. A method of facilitating flexibility and broad bandwidth capability of a multi-band, multi-mode radio frequency (RF) front-end module, comprising the steps of:
transmitting a transmit (TX) signal within a first range of frequencies via a respective one of a plurality of TX paths;
using a switch, selectively coupling the plurality of TX paths to one broadband power amplifier operable to amplify TX signals within the first range of frequencies;
transmitting a second TX signal within a second range of frequencies via a respective one of a second plurality of TX paths; and
using a second switch, selectively coupling the second plurality of TX paths to a second broadband power amplifier operable to amplify TX signals within the second range of frequencies.

21. The method of claim 20, wherein
the first range of frequencies is at least one of from about 700 MHz to about 900 MHz, from about 1710 MHz to about 1910 MHz, or from about 1920 MHz to about 2570 MHz; and
the second range of frequencies is at least one of from about 700 MHz to about 900 MHz, from about 1710 MHz to about 1910 MHz, or from about 1920 MHz to about 2570 MHz.

22. The method of claim 20, further comprising the steps of:
transmitting a third TX signal within a third range of frequencies via a respective one of a third plurality of TX paths; and
using a third switch, selectively coupling the third plurality of TX paths to a third broadband power amplifier operable to amplify TX signals within the third range of frequencies.

23. The method of claim 22, wherein the third range of frequencies is at least one of from about 700 MHz to about 900 MHz, from about 1710 MHz to about 1910 MHz, or from about 1920 MHz to about 2570 MHz.

24. A method of facilitating flexibility and broad bandwidth capability of a multi-band, multi-mode radio frequency (RF) front-end module, comprising the steps of:
transmitting a respective one of a plurality of transmit (TX) signals via a respective one of a plurality of TX paths, each TX path being operatively connected to a respective one of a plurality of bandpass filters, wherein the bandpass filters are configurable to reject unwanted signals on the respective TX paths;
receiving a respective one of a plurality of receive (RX) signals via a respective one of a plurality of RX paths, each of a number of the RX paths being operatively connected to a respective one of a plurality of duplexers, wherein the duplexers are configurable to isolate TX signals and RX signals;
using a first switch, selectively coupling the TX paths to a broadband power amplifier operable to amplify TX signals within a range of frequencies; and
using a second switch, selectively coupling a respective one of the duplexers to the TX path selected by the first switch.

25. The method of claim 24, wherein the range of frequencies is at least one of from about 700 MHz to about 900 MHz, from about 1710 MHz to about 1910 MHz, or from about 1920 MHz to about 2570 MHz.
